(19) United States
(12) Patent Application Publication
(10) Pub. No.: US 2013/0088075 A1
(43) Pub. Date: Apr. 11, 2013

(54) BICYCLE COMPONENT AND METHOD FOR MOUNTING OF A BICYCLE COMPONENT

(71) Applicants: Stefan Spahr, Lengnau (CH); Martin Walthert, Aarberg (CH)

(72) Inventors: Stefan Spahr, Lengnau (CH); Martin Walthert, Aarberg (CH)

(21) Appl. No.: 13/585,308

(22) Filed: Aug. 14, 2012

(30) Foreign Application Priority Data
Aug. 17, 2011 (DE) 10 2011 110 496.1

(51) Int. Cl. B60B 27/02; B60B 31/00

(52) U.S. Cl. CPC B60B 27/023; B60B 31/005
USPC 301/110.5; 29/894.33

(57) ABSTRACT

Bicycle component and method for assembling a bicycle component comprising several units of which one unit is configured as a fixed unit and at least one unit, as a rotary unit. A fixed unit forms the hub axle and a rotary unit is configured as a hub body. The hub body is provided with a spoke socket for fastening spokes and is rotatably supported relative to the hub axle by means of at least one bearing. At least one separate sealing cap fastened at one of the several units is provided at which a sealed through opening for a unit is provided which unit is rotatable relative to the hub body.

The present invention relates to a bicycle component and a method for mounting a bicycle component, the bicycle component being provided for at least partially muscle-powered vehicles and in particular bicycles. This bicycle component is in particular configured as a hub and it may be configured both as a front wheel hub and a rear wheel hub.

Many different types of hubs for bicycles and for other bi- and multicycles have become known in the prior art. Most hubs comprise a hub body which is rotatably supported relative to the stationary hub axle by way of two or more bearings. To prevent the lubricant in the bearings from being washed out and to avoid entry of dust and other dirt into the bearings, seals are as a rule provided to protect the bearings from environmental inclusions [sic].

In the field of sports and also in competitions for use in road races and also in mountain bike competitions, there are high requirements for each of the bicycle components and in particular for the front wheel and rear wheel hubs. Reliability of function and ease of maintenance are significant features of these hubs.

The weight of the components is another significant parameter.

Rear wheel hubs tend to comprise a rotor at which a sprocket cluster or a plurality of individual sprockets can be disposed to provide the user with a plurality of transmission variants.

Therefore rear wheel hubs are as a rule provided with a freewheel to obtain a reliable transmission of the driving force from the rotor to the hub body while the freewheel decouples the rotor from the hub body for example while the user is not pedaling in downhill rides or for example while back-pedaling. The reliable function of the freewheel is of great significance for safety in riding. Therefore the freewheel tends to be protected from environmental influences by a separate seal.

With DE 10 2007 030 190 A1, a hub has become known which is provided with a toothed disk freewheel. This toothed disk freewheel provides for pairs of axially toothed disks to be biased toward one another so as to transmit the drive torque from one of the toothed disks to the other of the toothed disks when in engagement. While no drive torque is being applied or the user is for example backpedaling, the axial teeth glide along one another and are urged away from one another against the biasing force so as to realize a freewheeling function.

The interior space in such a hub is limited. One of the toothed disks of the toothed disk freewheel tends to be disposed inside the rotor while the other of the toothed disks transmits the torque applied to the hub body. Since as a rule the hub body consists of a light-weight and medium-strength material, this known hub provides for the toothed disk to be received in the hub body in a threaded ring which threads into the hub body. The threaded ring can be exchanged in the case of wear so as to increase the service life of the hub.

What is important for the function of the hub is the seal between the hub body and the rotor to protect the freewheel from water and dust.

Although this hub operates reliably it is somewhat complicated in design and assembly since each of the components must be reliably assembled in the confined space, not involving a lot of effort.

It is therefore the object of the present invention to provide a bicycle component and a method for mounting a bicycle component allowing reliability of operation and involving reduced complexity in its structure and in mounting.

This object is solved by a bicycle component according to the invention having the features of claim 1. The method according to the invention is the subject matter of claim 14. Preferred specific embodiments of the invention are the subjects of the subclaims. Further advantages and features of the present invention can be taken from the general description and the description of the exemplary embodiments.

A bicycle component according to the invention is provided to be employed in at least partially muscle-powered vehicles and in particular two-wheeled vehicles. The bicycle component comprises several units of which at least one unit is configured as a fixed unit and at least one unit, as a rotary unit. A fixed unit forms at least part of a hub axle. A rotary unit is configured as a hub body. The hub body is provided with at least one spoke socket for fastening at least one spoke. The hub body is rotatably supported relative to the hub axle by means of at least one bearing. At least one separate sealing cap fastened at least at one of the several units is provided at which an at least partially sealed through opening for at least one unit is provided which unit is rotatable relative to the hub body.

The bicycle component according to the invention has many advantages. The bicycle component configured in particular as a hub is simple in structure and easy to assemble. Mounting and structure are simplified by the fact that a separate sealing cap is provided as an outwardly seal for the hub body.

The sealing cap may be configured for example as a covering ring or a sealing ring.

The sealing cap comprises at least and in particular precisely one through hole through which, when assembled as intended, at least one bicycle component unit passes. The through hole at the sealing cap is at least partially sealed to protect in particular the interior of the bicycle component from environmental influences. Preferably at least one unit passing through the through hole at the sealing cap is the hub axle. Or else it is possible for other fixed and/or rotary units to pass through the through hole.

In particular is the sealing cap disposed at the hub body to rotate along. The sealing cap is in particular fixedly connected with the hub body. The sealing cap is preferably provided detachable.

In all the configurations it is preferred for the sealing cap or at least one sealing cap to comprise at least one sealing unit. The sealing unit may be configured as a complete seal or else form a seal together with another sealing unit.

In particular at least one sealing cap of the at least one sealing cap comprises a labyrinth seal as the sealing unit and/or at least one elastomeric seal as the sealing unit. Or else it is possible for the sealing cap to comprise a contactless labyrinth seal and a contacting seal of an elastic material.

Particularly preferably at least one sealing cap of the at least one sealing cap is screw-coupled with the hub body. The sealing cap is preferably provided with an external thread and screws into an internal thread of the hub body. Or else it is possible for the sealing cap to comprise an internal thread which screws onto an external thread at the hub body. Screw-coupling the sealing cap with the hub body results in receiving the sealing cap at the hub body secure against loss. Moreover, other components can be secured at the hub body by means of the sealing cap.

Or else it is possible for the sealing cap to be provided for example with a peripheral groove or the like with an O ring inserted to thus obtain a clamping accommodation of the sealing cap in the hub body.

Preferably at least one guide means is provided in the hub body interacting with at least one guide means at the sealing cap to ensure defined accommodation of the sealing cap at the hub body. For example a shoulder may be provided in the hub body causing a defined and presently in particular centered accommodation of the sealing cap at the hub body when the sealing cap is pushed into the hub body with a cylinder-shaped portion. This defined guide and accommodation of the sealing cap at the hub body is in particular advantageous when the sealing cap screws into the hub body and is provided with a seal. Since as a rule a thread has a certain radial play, these guide means achieve a precisely defined positioning of the sealing cap at the hub body which is significant in particular for a sealing function.

The or at least one sealing cap is in particular fastened to a rotary unit and in particular to the hub body. It is also possible to fasten the or at least one sealing cap at a fixed unit. The sealing cap can for example be fastened at the hub axle or an adapter ring or the like devices.

The bicycle component particularly preferably comprises a rotor for the rotary unit at which at least one sprocket or a sprocket cluster is to be disposed. It is also possible to fasten the or at least one sealing cap at the rotor or another rotary unit. In this design the bicycle component may be configured as the rear wheel hub of a bicycle. Then it is preferred to provide a sealing cap comprising a sealing unit for sealing the rotary hub body relative to the rotary rotor and the ambience.

In this configuration a freewheel and in particular a toothed disk freewheel is preferably provided comprising at least one toothed disk that is non-rotatably and axially displaceably received in an engagement component. It is possible for the toothed disk freewheel to comprise a pair of axially movable toothed disks each being non-rotatably and axially displaceably received in an engagement component. Preferably an engagement component is provided in the hub body. The other of the engagement components may be provided at the rotor as a separate part or else be formed by the rotor. It is also possible for an axially movable toothed disk to be received in an engagement component in the hub body while the other axial toothing is directly configured as a spur gear at the rotor.

At least one toothed disk of the toothed disk freewheel is non-round in its outer contour and may for example comprise an external toothing which is non-rotatably and axially displaceably disposed in a corresponding internal toothing of the engagement component. An engagement component is preferably screwed into the hub body. In such a configuration said engagement component may be provided as a threaded ring having a non-round inner contour mating with a non-round outer contour of the toothed disk so as to ensure a non-rotatable accommodation of the toothed disk in the engagement component and axial displaceability of the toothed disk relative to the engagement component.

Or else it is possible for the engagement component to be non-round in its outer contour and pushed into a corresponding non-round inner contour of the hub body such that the engagement component is non-rotatably received in the hub body. An axial disassembly is possible.

Particularly preferably this configuration provides for the engagement component to be secured in the axial direction by the sealing cap. In this respect the sealing cap may be called a retaining cap or a hub cap. For example the sealing cap can be screwed into the hub body thus axially fixing the engagement component in the hub body. This configuration allows a particularly simple structure and ease of mounting this bicycle component.

The hub body may be configured integrally or else be comprised of several separate parts which together form a rotary unit. Preferably the hub body comprises at least one and in particular two hub flanges wherein at least one hub flange is provided with spoke apertures extending outwardly for spokes. In this configuration the bicycle component is in particular provided for straight pull spokes. It is preferred for the spoke apertures to be formed as spoke holes and to be configured circumferentially closed. This is a particularly stable construction, allowing a lighter structure of the bicycle component since the wall thicknesses required are small. Or else it is possible for the spoke aperture to be configured with side slits so as to allow pushing the spokes into spoke apertures from the side. For fastening a plurality of spokes, providing a circumferential spoke flange is not required. It is also possible to provide separate spoke sockets for each spoke. Or else at least a spoke socket of any desired configuration serves for fastening a plurality of spokes.

Preferably the hub flange or the spoke socket is provided with at least one receiving space for at least one inner spoke end to thus allow disposing the spoke head in the receiving space. The receiving space is in particular covered by the sealing cap. This variant allows inserting into the spoke apertures the spokes required for assembling a wheel such that each of the spoke heads or inner spoke ends is provided at a receiving space. By means of covering the receiving space with the sealing cap the spokes are received at the hub secure against loss.

For example when blade spokes having flattened spoke heads are employed, an angular orientation of the spokes can be ensured in assembling and later use.

To reduce air drag of spoke wheels, spokes have become known whose spoke bodies are flattened and which have a blade-like structure. These spokes show considerably reduced flow resistance in the traveling direction. In these flattened spoke bodies it is important, however, for the spokes to be positioned in the direction of flow with their flattened sides since otherwise the flow resistance would not be reduced but possibly even increased over conventional spokes. A slight twist to the spoke body can already perceptibly increase air drag.

The interaction of the receiving space at the hub body for receiving the flattened, inner spoke end and in particular the flattened spoke head with the externally attached sealing cap allows to retain the spoke twist-proof so as to ensure low air drag.

In all the configurations and specific embodiments an adapter ring as an in particular fixed unit is preferably disposed at least at one end of the hub axle. Preferably each of the ends of the hub axle is provided with an adapter ring. The adapter rings extend the hub axle, providing receiving portions for the dropouts. It is possible for at least one sealing cap to be attached to at least one adapter ring.

In all the configurations at least part of the hub body consists of at least one lightweight material such as a light metal or a fibrous composite material. The toothed disks of a toothed disk freewheel preferably consist of steel.

The method according to the invention serves for assembling a bicycle component. Spokes are inserted into spoke apertures of the hub body such that the radially inwardly spoke ends of the spokes are disposed in a receiving space at the hub body. Thereafter a sealing cap is attached to the hub body such that the spokes are received at the hub secure against loss.

The method according to the invention also has many advantages since it allows easy and simple assembly of a bicycle component. The spokes can be inserted through side slits in the spoke apertures or else the spokes are guided outwardly through the hub body through the spoke apertures which are configured circumferentially closed, such that the radially inwardly spoke ends or spoke heads are disposed in a receiving space of the hub body. There the in particular flattened spoke heads can be laterally fixed by the sealing cap such that the spokes are received twist-proof at the hub.

Preferably the dimensions of the receiving space are dimensioned such that after being inserted into the hub body the spokes have little play. This allows greater ease of mounting the wheel subsequently.

When assembling a rear wheel hub the rotor is preferably not pushed on until after inserting the spokes. This allows to provide more space in the hub since for example the seal of the rotor is provided at the sealing cap and attached and in particular screwed in only after inserting the spokes.

In particular in the case of a rear wheel hub the rotor side is provided with many components significant for reliable function of the hub. For example the freewheel in the shape for example of a toothed disk freewheel is provided there. The seal between the rotor and the hub body extends axially outwardly in a conventional case. In case that straight-pull spokes are intended for use, then the spokes need to be inserted into the spoke holes from radially inwardly to the outside. In conventional hubs the seal may be an impediment. In conventional hubs this may result in that the outer diameter of the spoke flange needs to be enlarged for the straight-pull spokes to not collide with the sealing seat during linear insertion. This is a problem that increases with the quantity of the spokes and with a steeper spoke angle.

The spokes cannot be disposed any further axially outwardly since this is where the rotor with the sprocket cluster is disposed.

Thus the invention allows a simpler construction and easier assembly of such a hub. When mounting the spokes there is no inhibiting seal since the seal is removed together with the sealing cap. Only after mounting and inserting the spokes is the sealing cap attached and thus the seal brought to its operational position.

In this way the outer diameter of the spoke socket or of the hub flange can be reduced while concurrently even reducing the steepness of the spokes, in such a hub. In particular on the rotor side of a rear wheel hub the spokes are very steep so as to be subjected to high loads. Every tenth of a millimeter of axially outwardly displacement of the spoke holes will considerably reduce the spoke angle and thus the occurring loads. Moreover the lateral stiffness of the wheel is improved in this way.

Further advantages and features of the present invention can be taken from the description of the exemplary embodiments which will be discussed below with reference to the enclosed figures.

The drawings show in:

FIG. 1 a schematic side view of a racing bicycle equipped with hubs according to the invention;

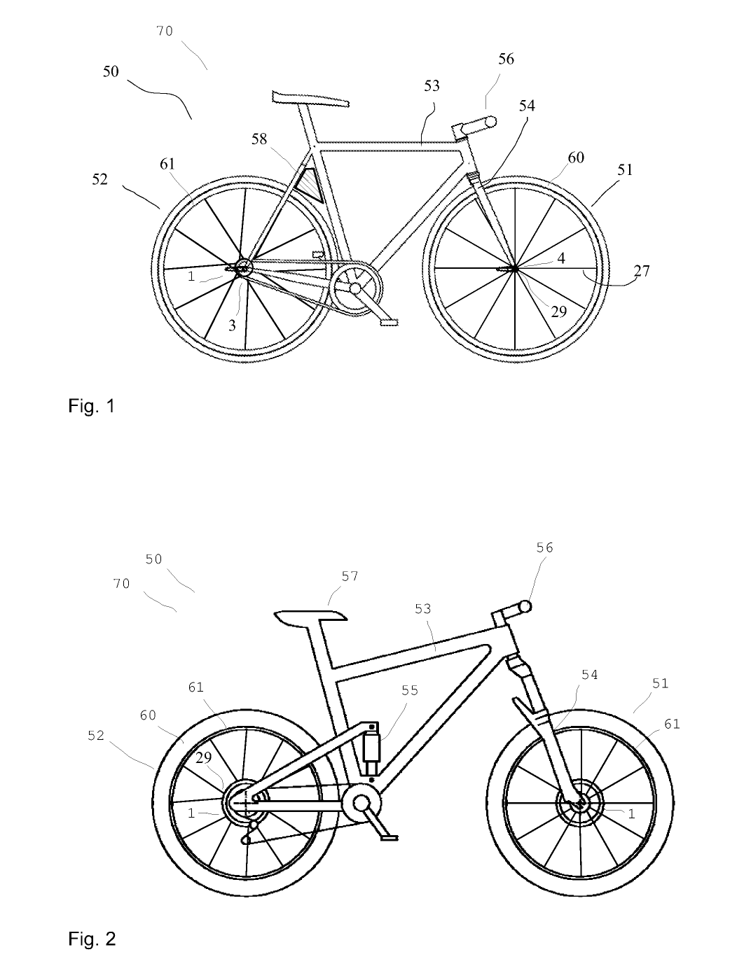

FIG. 2 a schematic side view of a mountain bike equipped with hubs according to the invention;

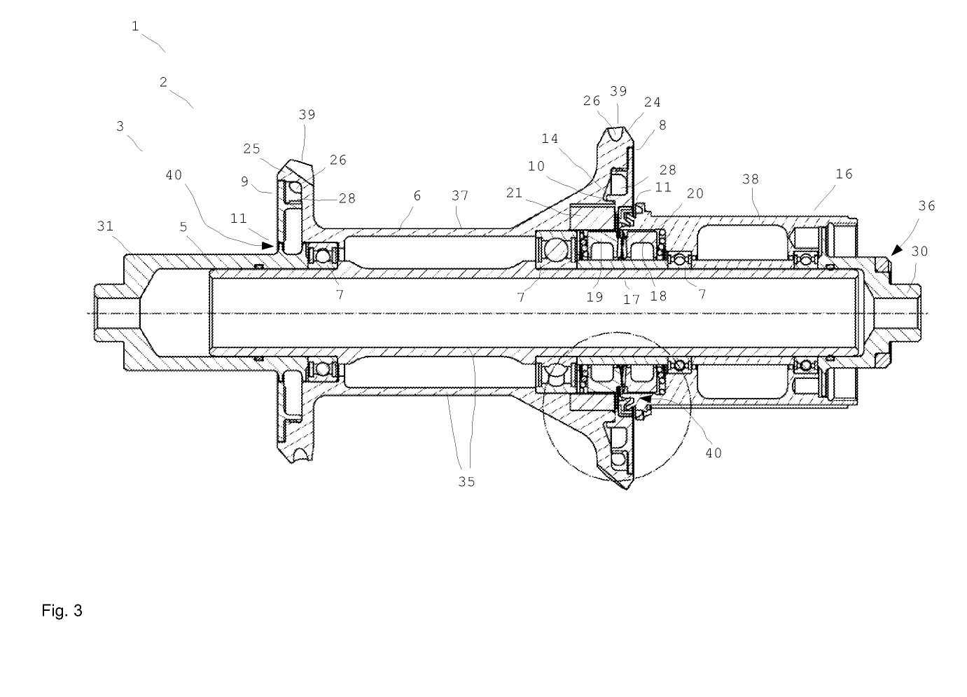

FIG. 3 a schematic cross-section of a first hub according to the invention;

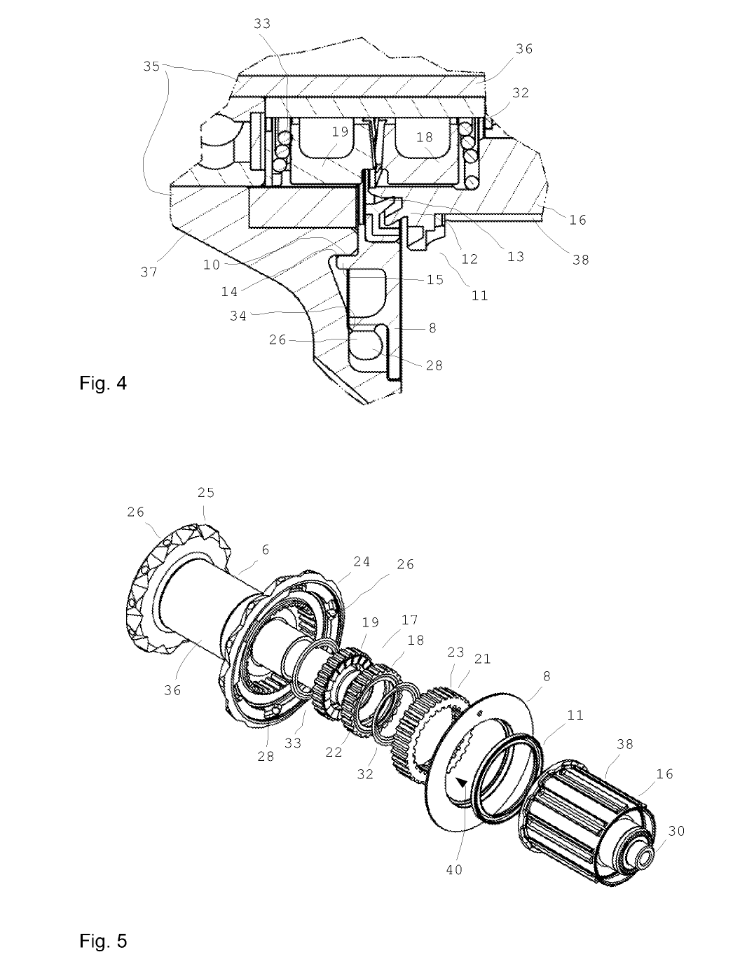

FIG. 4 an enlarged detail from FIG. 3;

FIG. 5 an exploded view of the hub according to FIG. 3;

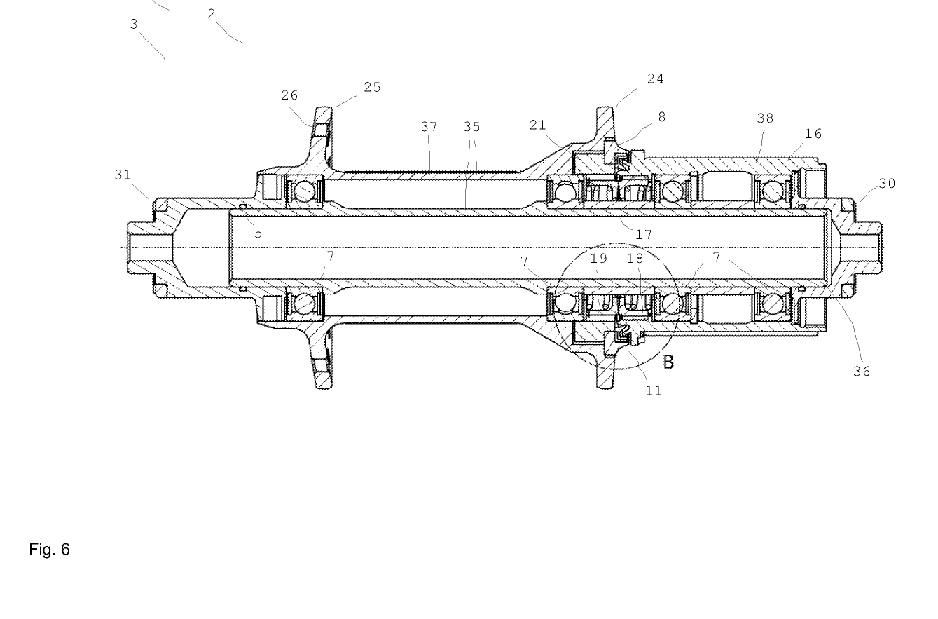

FIG. 6 a schematic cross-section of a second hub according to the invention;

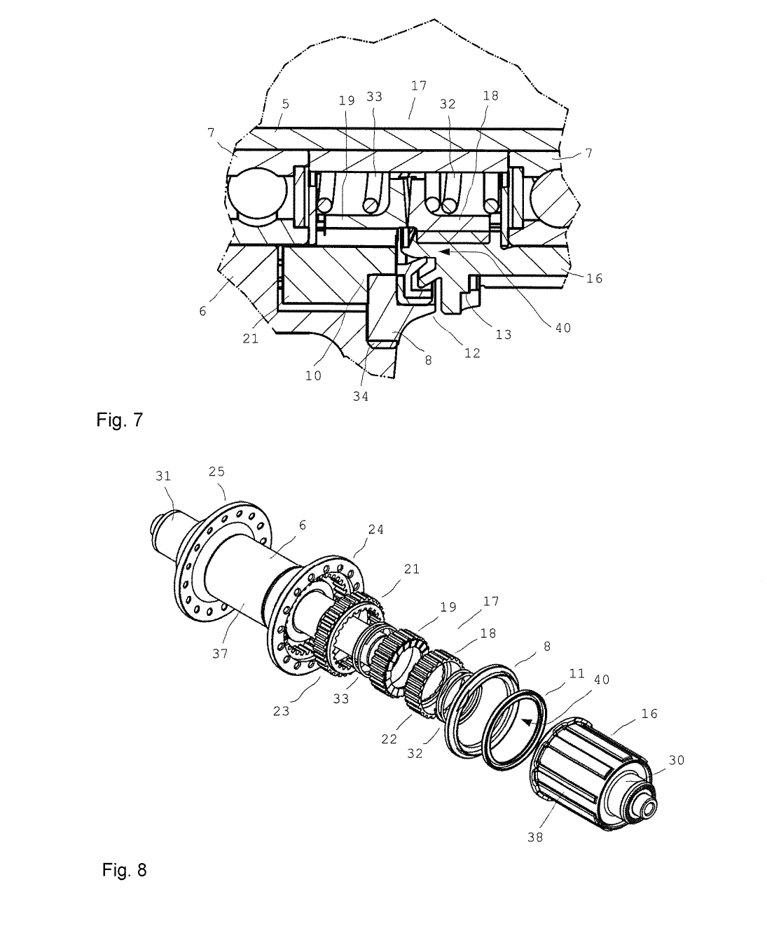

FIG. 7 an enlarged detail from FIG. 6;

FIG. 8 an exploded view of the hub according to FIG. 6;

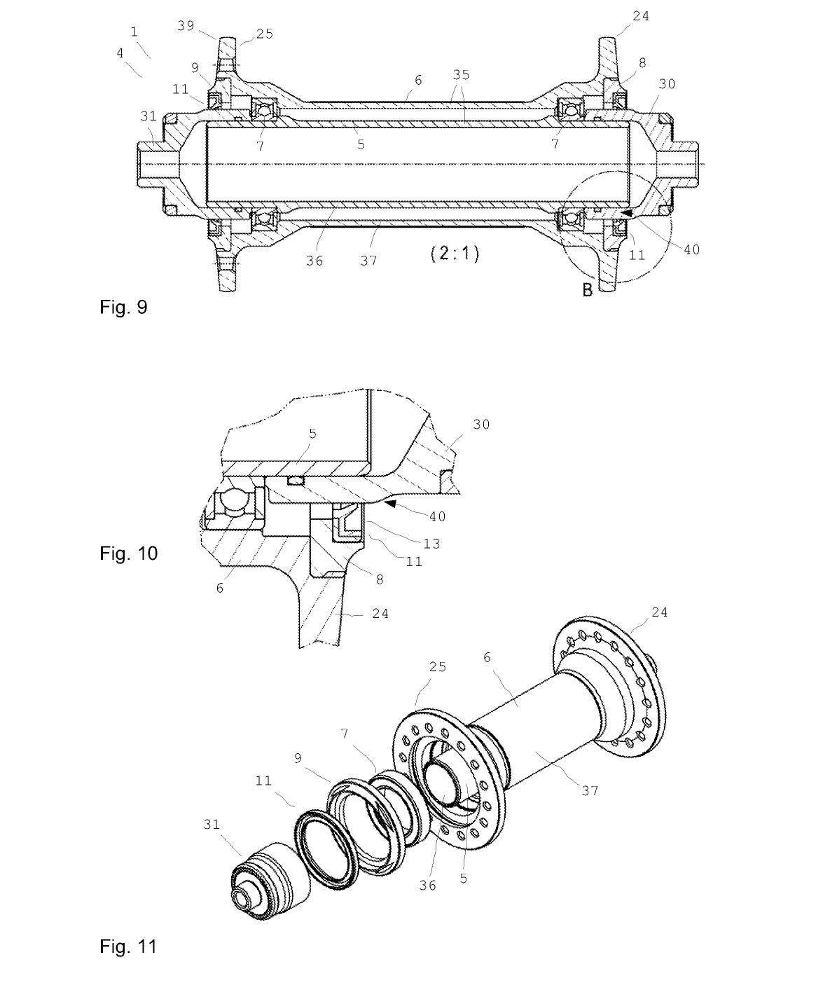

FIG. 9 a schematic cross-section of a third hub according to the invention;

FIG. 10 an enlarged detail from FIG. 9; and

FIG. 11 an exploded view of the hub according to FIG. 9.

In FIG. 1 a vehicle 70 configured as a two-wheeled vehicle 50 and in particular as a racing bicycle is illustrated in a schematic side view. The bicycle 50 is muscle-powered at least in part and may be provided with an electric auxiliary drive.

The racing bicycle is illustrated in a simplistic side view and comprises a front wheel 51 and a rear wheel 52 and a frame 53. A handlebar 56 serves as a control and may have different configurations. Apart from a racing handlebar configuration other known configurations are conceivable as well.

Beneath the saddle 57 a battery 58 may be provided which is employed in particular for electro-assisted two-wheeled vehicles. Generally speaking, such a battery 58 may be attached to the frame in other places or incorporated into the frame or attached elsewhere.

In the bicycle according to FIG. 1 the tire 60 may be configured as a tubeless tire and for example be glued onto the rim 61. The rims 61 of the front wheel 51 and the rear wheel 52 are each connected with the hub via spokes 27.

The rear wheel 52 is provided with a hub 1 according to the invention as the rear wheel hub 3 while the front wheel comprises a hub according to the invention as a front wheel hub 4.

In FIG. 2 a mountain bike bicycle 50 is illustrated in a simplistic side view comprising a front wheel 51 and a rear wheel 52, a frame 53, a sprung front fork 54 and a rear wheel damper 54. In this exemplary embodiment, disk brakes are provided. The rear wheel 52 is provided with a rear wheel hub 3 according to the invention and the front wheel 51 is provided with a front wheel hub 4 according to the invention.

FIG. 3 shows a simplistic cross-section of a bicycle component 1 according to the invention which is presently configured as a rear wheel hub 3. The rear wheel hub 3 is suitable to be employed with the bicycle according to FIG. 1 or 2.

The rear wheel hub 3 is provided with a hub axle 5 and a hub body 6 which is supported rotatably relative to the hub axle 5 by means of multiple bearings 7. The lateral ends are provided with adapter rings 30 and 31.

A toothed disk freewheel 17 with toothed disks 18 and 19 is disposed between the rotor 16 and the hub body 6 for transmitting the drive torque of the rotor to the hub body.

The toothed disks 18 and 19 comprise an axial toothing each via which the two toothed disks 18 and 19 are engaged with one another for the transmission of rotational force.

The toothed disks 18 and 19 are non-round in their outer cross-sections and they are each non-rotatably and axially displaceably received in engagement components 20 or 21 respectively. The engagement component 20 is formed by the rotor 16 while the engagement component 21 is provided as a separate part in the hub body 6.

In the present exemplary embodiment the toothed disks 18 and 19 are provided with external toothings by which they are received in the rotor 16 and in the engagement component 21 respectively non-rotatably though axially displaceably.

The hub body 6 comprises hub flanges 24 and 25 at which spoke apertures in the shape of spoke holes 26 are provided.

On the rotor side the hub flange 24 is provided while the hub flange 25 is disposed on the other side.

In the present exemplary embodiment the hub 2 configured as a rear wheel hub 3 is provided for employing straight-pull spokes 27. These spokes are extended longitudinally and are linearly guided through the spoke holes 26 until they are received for example by their spoke heads in the receiving space 28 at the hub flanges 24 or 25.

In the receiving space 28 the spokes 27 are received secure against loss by means of the sealing caps 8 or 9. The sealing caps 8 and 9 are screwed into the spoke flanges 24 and 25. In this way the sealing caps 8 and 9 retain the spokes 27 at the hub secure against loss such that the further mounting of the wheel is simpler.

The sealing caps 8 and 9 are each provided with sealing units 11 for sealing the hub body 6 outwardly. At the hub flange 9 the sealing unit 11 interacts with the adapter ring 31 so as to protect the interior of the hub body 6 and in particular the bearings 7 against environmental influences.

The sealing cap 8 on the side of the rotor 16 is screwed into the hub flange 24 and is likewise provided with a sealing unit 11. Presently the sealing unit 11 of the sealing cap 8 interacts with the rotor such that both a labyrinth seal and a contacting elastomer seal is present between the hub body 6 and the rotor 16. In this way the interior of the hub body 6 and in particular the toothed disk freewheel 17 is protected from environmental influences.

On the whole FIG. 3 shows a bicycle component 1 configured as a hub 2 and presently as a rear wheel hub 3 comprising several units 35 to 38. The unit 36 is configured as a fixed unit 35 presently consisting of the adapters 30 and 31 and the hub axle 5. Or else it is possible for the fixed unit 35 to only consist of the hub axle 5.

The hub body 6 forms a rotary unit 37 which is rotatably supported on the hub axle 5 via bearings 7. The hub body 6 presently comprises hub flanges 24, 25 as the spoke sockets 39 for fastening the spokes 27.

Presently two separate sealing caps 8 and 9 fastened to rotary units 38 are provided. The sealing cap 8 is presently fastened to the rotary unit 37 although it might be fastened to the rotary unit 38. The sealing cap 8 comprises a through hole 40 for the rotor 16 to pass through as the rotary unit 38 and the fixed hub axle, as the fixed unit 36.

The sealing cap 8 presently seals the interior of the hub 2 relative to the rotor 16 as the unit 38. The rotor 16 is disposed rotatably relative to the hub body 6 or the hub body 6 can freely rotate relative to the rotor 16 in the freewheeling direction.

The sealing cap 9 is likewise fastened to the hub body as the rotary unit 37 although it might be fastened to the adapter 31 and thus to the rotary unit 36.

Basically all of the configurations may be provided with at least one separate sealing cap that is fastened to a stationary or rotary unit and which is provided with an at least partially sealed through hole. At least one stationary and/or rotary unit rotatable relative to the hub body passes through the through hole.

FIG. 4 shows an enlarged section of the dash-dotted details in FIG. 3 to still better clarify the construction and arrangement of the sealing cap at the hub body 6.

The toothed disk freewheel 17 comprises springs 32 and 33 which press against the toothed disks 18 and 19 from axially outwardly so as to bias the toothed disks toward one another.

The present sealing unit 11 comprises sealing units 12 and 13 which realize the contactless labyrinth seal and the contacting elastomeric seal 13.

The sealing cap 8 is screwed into the hub body 6 by way of the thread 34. Centering the sealing cap 8 is done via the guide means 14 in the shape of a shoulder 10 in the hub body and the guide means 15 in the shape of a cylindrical tubular part at the sealing cap 8.

In particular the illustration according to FIG. 4 shows that after removing the rotor and the sealing cap 8 or prior to mounting the sealing cap 8 and the rotor 16 the spokes 27 can easily be inserted through the spoke holes 26 since much space is provided. After inserting the spokes 27 into the receiving spaces 28 the sealing cap 8 is screwed on such that the hub 3 is equipped with the spokes extending approximately in a star configuration. Thereafter the rotor 16 is attached. The guide means 14 and 15 provide for centering the sealing cap 8. The rotor is centered via the bearings 7 so as to provide a precisely defined positioning of the rotor relative to the sealing cap 8 and the hub body 6.

FIG. 5 shows an exploded view of the rear wheel hub 3 with the recesses at the receiving spaces 28 of the hub flange 24 readily recognizable. Basically it is possible to configure the receiving space 28 as a circumferential receiving space.

In FIG. 5 one can furthermore recognize that the engagement component 21 is non-round in its outer contour 23 for the engagement component 21 to be received twist-proof in the hub body 6 which comprises a corresponding, non-round contour.

In analogy thereto the toothed disks 18 and 19 are provided with corresponding external toothings 22 or non-round contours to engage in a corresponding inner contour of the engagement components 20 and 21 such that the toothed disks 18 and 19 are non-rotatably but axially displaceably received in the engagement components 20 and 21.

With reference to the FIGS. 6 to 8 a second exemplary embodiment of a bicycle component 1 according to the invention will now be discussed which is presently again configured as a rear wheel hub 3.

The rear wheel hub 3 comprises a hub axle 5 and a hub body 6 which is provided with hub flanges 24 and 25. In the hub flanges approximately axially arranged spoke holes 26 are provided for receiving conventional spokes.

The hub body 6 is supported rotatably relative to the hub axle 5 by means of multiple bearings 7. Adapters 30 and 31 are pushed onto the axial ends and secured to the hub axle 5 via O rings received in grooves. The hub 2 is fastened to the dropouts of a bicycle by means of the adapter rings 30 and 31.

The rear wheel hub 3 is provided with a toothed disk freewheel 17 with toothed disks 18 and 19 which are biased toward one another in the axial direction via springs 32 and 33.

On the side of the rotor 16 serving to receive a sprocket cluster having multiple sprockets a sealing cap 8 with a sealing unit 11 is provided.

The sealing cap 8 screws into the hub body 6 via a screw thread 34, thus securing the axial position of the engagement component 21 at which the toothed disk 19 is non-rotatably and axially movably received.

The hub 2 illustrated in FIG. 4 is also configured as a rear wheel hub 3 and comprises several units 35 to 38. The unit 36 is configured as a fixed unit 35 presently consisting of the adapters 30 and 31 and the hub axle 5.

The hub body 6 forms a rotary unit 37 which is rotatably supported on the hub axle 5 via bearings 7.

Again two separate sealing caps 8 and 9 fastened to the hub body 6 are provided. The sealing cap 8 comprises a through hole 40 for the rotor 16 as the rotary unit 38. The sealing cap 8 comprises a through hole 40 for the fixed hub axle as the fixed unit 36.

The sealing cap 8 seals the interior of the hub 2 relative to the rotor 16 as the unit 38. The rotor 16 is disposed rotatably relative to the hub body 6 or the hub body 6 can freely rotate relative to the rotor 16 in the freewheeling direction.

FIG. 7 shows the enlarged detail from FIG. 6. The sealing cap 8 screwed into the hub body 6 by way of the screw thread 34 bears sealing units 11 which by way of interacting with the rotor 16 presently form a contactless labyrinth seal 12 and a contacting elastomeric seal 13. In this way the interior of the hub body 6 and in particular the toothed disk freewheel 17 is protected from environmental influences. Centering the sealing cap 8 is caused via a shoulder 10. The engagement component 21 in turn is received centered at the hub 2 via the bearing 7.

FIG. 8 shows an exploded view of the rear wheel hub 3 according to FIG. 6 wherein the non-round outer contour 23 of the engagement component 21 is again recognizable.

The sealing unit 11 may be attached to the sealing cap 8 as a separate component such that the sealing unit 11 is exchangeable as needed.

With reference to FIGS. 9 to 11 another exemplary embodiment of a bicycle component 1 according to the invention is embodied which is presently configured as a front wheel hub 4.

The front wheel hub 4 according to FIG. 9 comprises a hub axle 5 and a hub body 6, which is rotatably supported relative to the hub axle 5 via bearings 7. The axial ends are provided with adapter rings 30 and 31 which with their outer ends are pushed into the dropouts of a bicycle fork or a bicycle frame.

The front wheel hub 4 is presently provided with spoke flanges 24 and 25 to which conventional spokes are fastened. Or else it is possible to fasten straight-pull spokes if corresponding other configurations of hub flanges 24 and 25 are employed. Both ends of the hub body 6 are presently provided with sealing caps 8 and 9 each having a sealing unit 11. It is possible for the sealing units to be configured as labyrinth seals 12 or as elastomeric seals 13 and to provide a corresponding sealing function in interaction with the hub axle.

FIG. 10 shows the enlarged detail from FIG. 9. Again the sealing cap 8 is screwed into the hub body 6. Or else it is possible for the sealing cap 8 to be clamp-fastened in the hub body 6 via an O ring disposed in an outer peripheral groove. Then the sealing cap 8 is retained in the hub body 6 in a similar way as the adapter rings 30 or 31 are clamp-fastened on the hub axle 5.

FIG. 11 shows an exploded view of the front wheel hub 4 in FIG. 9 wherein the sealing unit 11 is again provided exchangeable at the sealing cap 9.

The hub 2 discussed with reference to FIGS. 9 to 11 is configured as a front wheel hub 4 and comprises several units 35 to 37. The unit 36 being the hub axle 5 is configured as a fixed unit 35. The hub body 6 forms a rotary unit 37 which is rotatably supported on the hub axle 5 via bearings 7.

The sealing caps 8 and 9 fastened to the hub body 6 each seal the through hole 40 inwardly. The hub axle 5 presently passes through the through hole 40. The hub axle 5 is disposed rotatably relative to the hub body 6.

On the whole a bicycle component is provided that is simple in structure and permits safety of function and ease of mounting. Both employing a conventional spoking and employing straight-pull spokes is possible.

### LIST OF REFERENCE NUMERALS

1 bicycle component 27 spoke

2 hub 28 receiving space

3 rear wheel hub 29 inner spoke end

4 front wheel hub 30 adapter ring

5 hub axle 31 adapter ring

6 hub body 32 spring

7 bearing 33 spring

8 sealing cap 34 screw thread

9 sealing cap 35 unit

10 shoulder 36 fixed unit

11 sealing unit 37 rotary unit

12 labyrinth seal 38 rotary unit

13 elastomeric seal 39 spoke socket

14 guide means 40 through hole

15 guide means 50 bicycle

16 rotor 51 front wheel

17 toothed-disk freewheel 52 rear wheel

18 toothed disk 53 frame

19 toothed disk 54 fork

20 engagement component 55 rear wheel damper

21 engagement component 56 handlebar

22 external toothing of the 57 saddle

toothed disk 58 battery

23 non-round outer contour 60 tire

24 rotor side hub flange 61 rim

25 hub flange 70 vehicle

26 spoke hole

1. Bicycle component (1-4) for at least partially muscle-powered vehicles (70) and in particular two-wheeled vehicles (50) having several units (35-38), at least one of said units (36) being configured as a fixed unit (36) and at least one of the units (37, 38) being configured as a rotary unit (37, 38),
wherein one fixed unit (36) forms at least part of a hub axle (5),
and wherein a rotary unit (37) is configured as a hub body (6),
wherein the hub body (6) is provided with at least one spoke socket (39) for fastening at least one spoke (27) and is rotatably supported relative to the hub axle (5) via at least one bearing (7),
characterized in
that at least one separate sealing cap (8, 9) is provided that is fastened at least at one of the several units (35-38),
at which an at least partially sealed through opening (40) for at least one unit (36, 38) is provided which unit (36, 38) is rotatable relative to the hub body (6).

2. The bicycle component (1) according to claim 1, wherein at least one sealing cap (8, 9) is provided with at least one sealing unit (11) wherein in particular at least one labyrinth seal (12) as the sealing unit (11) and/or at least one elastomeric seal (13) as the sealing unit (11) is provided.

3. The bicycle component (1) according to at least one of the preceding claims wherein at least one sealing cap (8, 9) is screwed with the hub body (6).

4. The bicycle component (1) according to at least one of the preceding claims wherein at least one guide means (14) is provided in the hub body (6) interacting with at least one guide means (15) at the sealing cap (8, 9) to ensure a defined accommodation of the sealing cap (8, 9) at the hub body (6).

5. The bicycle component (1) according to at least one of the preceding claims wherein a rotor (16) is provided.

6. The bicycle component (1) according to at least one of the preceding claims wherein a toothed disk freewheel (17) having at least one toothed disk (18, 19) is provided and wherein the toothed disk (18, 19) is non-rotatably and axially displaceably received in an engagement component (20, 21).

7. The bicycle component (1) according to at least one of the preceding claims wherein the engagement component (20, 21) is screwed into the hub body (6).

8. The bicycle component (1) according to claim 7, wherein the engagement component (20, 21) is non-round in its outer contour (23) and is pushed into a non-round inner contour of the hub body (6) such that the engagement component (20, 21) is non-rotatably received in the hub body (6).

9. The bicycle component (1) according to at least one of the preceding claims wherein the engagement component (20, 21) is secured in the axial direction by the sealing cap (8, 9).

10. The bicycle component (1) according to at least one of the preceding claims wherein the spoke socket (39) comprises spoke holes (26) extending outwardly for spokes (27).

11. The bicycle component (1) according to at least one of the preceding claims wherein at the spoke socket (39) at least one receiving space (28) for at least one inner spoke end (29) is provided wherein the receiving space (28) is covered by the sealing cap (8, 9).

12. The bicycle component (1) according to the preceding claim wherein at least one spoke (27) is received in the receiving space (28) with its inner spoke end (29) and is retained twist-proof by the sealing cap (8, 9).

13. The bicycle component (1) according to at least one of the preceding claims wherein an adapter ring (30, 31) is disposed at least at one end of the hub axle (5) and wherein the sealing cap (8, 9) is fastened to the adapter ring or the hub body (6).

14. Method for assembling a bicycle component (1) wherein spokes (27) are inserted into spoke apertures (26) of the hub body (6) such that the radially inwardly spoke ends (29) of the spokes (27) are arranged in a receiving space (28) at the hub body (6) wherein a sealing cap (8, 9) is subsequently attached to the hub body (6) such that the spokes (27) are received at the hub (2) secure against loss.

15. The method according to the preceding claim wherein subsequently the rotor (16) is disposed.
